(19) United States
(12) Patent Application Publication
(10) Pub. No.: US 2007/0274231 A1
(43) Pub. Date: Nov. 29, 2007

(54) System and method for improving the performance and stability of Serial Attached SCSI networks

(75) Inventors: Kevin T. Marks, Round Rock, TX (US); Gary B. Kotzur, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/440,190

(22) Filed: May 24, 2006

(51) Int. Cl. H04L 12/28

(52) U.S. Cl. 370/254

(57) ABSTRACT

A system and method is disclosed for managing configuration discovery following a loss or acquisition of link synchronization on a link in a network having a SAS architecture with one or more expanders. When a loss or acquisition of link synchronization on a link is identified, the IDENTIFY address frame is examined to determine if a discovery sequence should be performed by the initiator ports of the network. Depending on whether a target port or an initiator port is involved in the loss or acquisition of link synchronization, a broadcast primitive may not be issued, or may only be issued to the initiator ports or expander ports.

### TECHNICAL FIELD

The present disclosure relates generally to computer systems and information handling systems, and, more particularly, to a system and method for improving the performance and stability of Serial Attached SCSI networks.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

Information handling systems may be included as elements of a storage network. A storage network can be considered as a specialized network of storage devices coupled to one or more data servers. A storage network may include a number of storage elements or storage drives. Storage drives typically comprise disk-based storage drives. Serial Attached SCSI (SAS) is a storage network interface and communications protocol for storage transactions. SAS storage networks are characterized as having a serial, point-to-point architecture and improved data integrity, as compared with parallel SCSI storage networks. In a SAS storage environment, a phy is each endpoint of a transmitter-receiver (transceiver) pair. A phy may be included in an expander. In the example in which a phy is included in an expander, if (a) the link between the phy in the expander and another phy achieves double word (Dword) synchronization, (b) the link loses Dword synchronization, or (c) the phy contained in the expander is disabled, the phy in the expander will send a request to the Broadcast Primitive Processor associated with the phy to generate a BROADCAST (CHANGE) primitive. A primitive is a special Dword that is used to indicate some information or action.

The issuance of the BROADCAST (CHANGE) primitive causes each SAS initiator port to perform a domain discovery procedure to identify the changes to the SAS domain. The issuance of the BROADCAST (CHANGE) primitive also notifies management application clients that one or more expander route tables may need to be updated to account for the addition or removal of a SAS device. In a multi-initiator environment, issuing a BROADCAST (CHANGE) primitive each time that one of the initiator ports is reset becomes problematic. If a SAS storage environment includes a number of blade servers acting as initiator ports, for example, the resetting of a single blade server will cause all of the blade servers to initiate a new discovery process and may update the routing table in one or more expanders. In some configurations, each blade server will send commands to a single Serial Management Protocol (SMP) target port, resulting in contention during the discovery process and the steps of updating route tables in the expander.

### SUMMARY

In accordance with the present disclosure, a system and method is disclosed for managing configuration discovery following a loss or acquisition of link synchronization in a network having a SAS architecture with one or more expanders. When a loss or acquisition of link synchronization occurs, the IDENTIFY address frame exchanged between phys prior to the loss of link synchronization or after the acquisition of link synchronization is examined to determine if the port attached to the expander port is a target port. If the SAS domain includes only a single expander and if the port attached to the expander port is a target port, a broadcast primitive is issued to cause the ports of the domain to begin a discovery sequence. If the port attached to the expander port is not a target port, a broadcast primitive is not initiated. If the SAS domain includes multiple expanders, the IDENTIFY address frame exchanged between phys prior to the loss of link synchronization or after the acquisition of link synchronization is examined to determine if the port attached to the expander port is a target port. If the port attached to the expander port is a target port, a broadcast primitive is issued only to the initiator ports to cause the initiator ports to conduct a discovery sequence to recognize any configuration changes in the target ports of the network. If the port attached to the expander port is an initiator port, a broadcast primitive is issued only to expander ports attached to other expander ports to cause the expanders to update their route tables.

The system and method disclosed herein is technically advantageous because it provides a method for managing the discovery sequence of a network in a manner that minimizes or eliminates the risk of contention in the network during the discovery sequence. Rather than initiating a new discovery following every configuration change between two phys, in those instances in which one of the phys is included in an expander, a targeted primitive is issued only in those instances in which the either the expander ports or the initiator ports should execute a discovery sequence to recognize configuration changes in the initiator ports and target ports of the network.

Another technical advantage of the system and method disclosed herein is that it is operable in SAS domains having only one expander and in SAS domains having multiple expanders. In a single-expander domain, the broadcast primitive is not issued unless one of the phys on the link that loses synchronization is a target port. In a multiple-expander domain, the broadcast primitive is issued only to expander ports attached to other expander ports if an initiator port is one of the phys on the link that loses or acquires link synchronization. Similarly, in a multiple-expander domain, the broadcast primitive is issued only to the initiator ports and expander ports attached to other expander ports if a target port is one of the phys on the link that loses or acquires link synchronization. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a SAS network that includes an expander;

FIG. 2 is a diagram of an IDENTIFY address frame;

FIG. 3 is a flow diagram of a method for managing the issuance of a broadcast primitive following the loss or acquisition of link synchronization in a domain having only one expander;

FIG. 4 is a diagram of a SAS network that includes multiple expanders;

FIGS. 5A and 5B are a flow diagram of a method for generating broadcast primitives following the loss or acquisition of link synchronization in a SAS domain having multiple expanders; and

FIG. 6 is a flow diagram of the method of generating broadcast primitives on expanders that receive a BROADCAST (CHANGE TARGET) or BROADCAST (CHANGE INITIATOR) primitive from another expander in the SAS domain.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

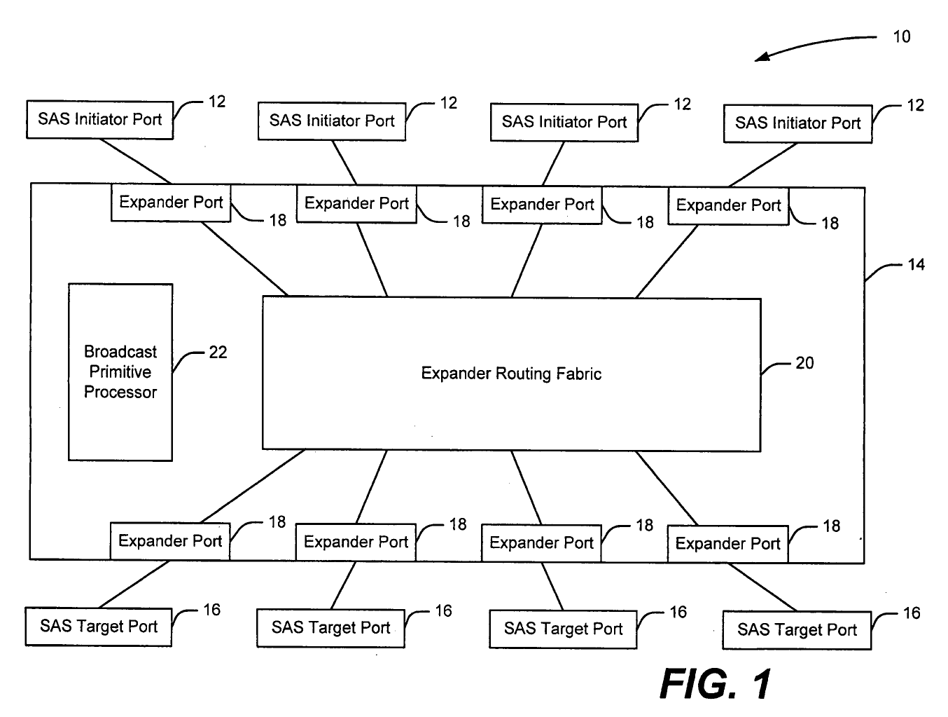

Shown in FIG. 1 is a diagram of a SAS network, which is indicated generally at 10. The domain of network 10 includes a single SAS expander 14. In the example of FIG. 1, expander 14 includes a number of expander ports 18 and a broadcast primitive processor 22, which may comprise a software utility that executes on the processor of expander 14. Each expander port of expander 14 is coupled to a SAS initiator port 12 or a SAS target port 16. Expander 14 also includes an expander routing fabric 20, which represents the point-to-point connections between the expander ports coupled to SAS initiators and expander ports coupled to SAS targets.

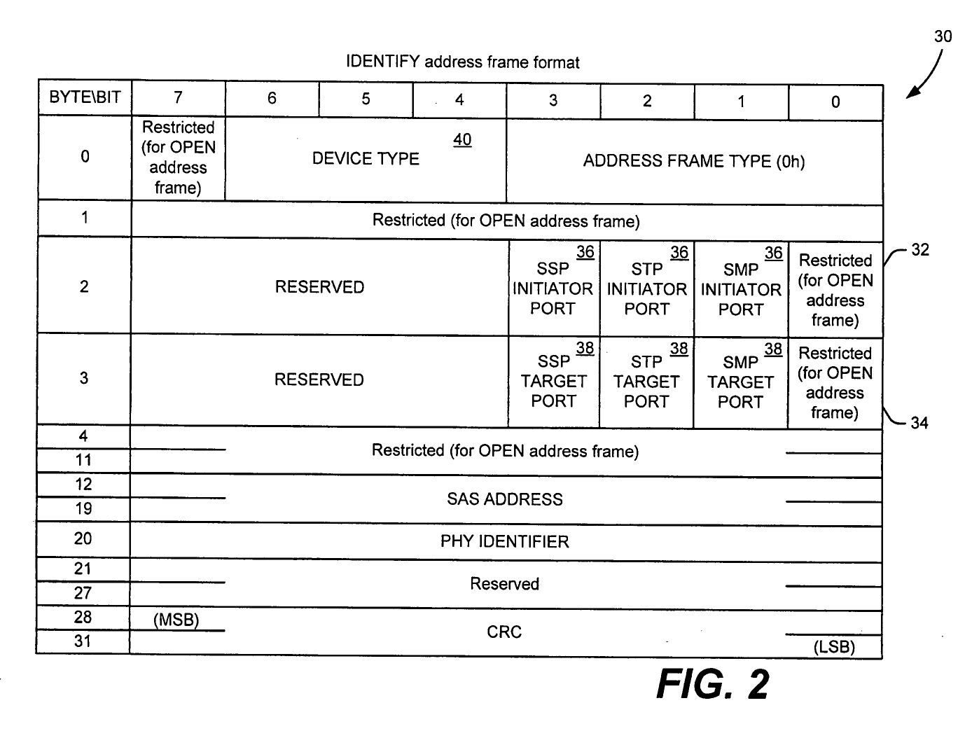

In operation, when the link between an expander phy and a phy contained in an initiator or target port acquires link synchronization, an IDENTIFY address frame is passed between the two phys and the IDENTIFY address frame data received on the expander phy is transmitted to the broadcast primitive processor. An example of the IDENTIFY address frame 30 is shown in FIG. 2. Identify address frame 30 includes thirty-two bytes, beginning with Byte 0. Byte 2, which is identified at 32, includes bit 3, bit 2, and bit 1, all of which are identified at 36. When set to a logical one, these bits identify if the phy that acquires link synchronization is an initiator port, such as initiator ports 12 in FIG. 1. Byte 3, which is identified at 34, includes bit 3, bit 2, and bit 1, all of which are identified at 38. When set to a logical one, these bits identify if the phy that acquires link synchronization is a target port, such as the target ports 16 in FIG. 1. The field device type 40 identifies whether the port that acquires link synchronization is an expander phy

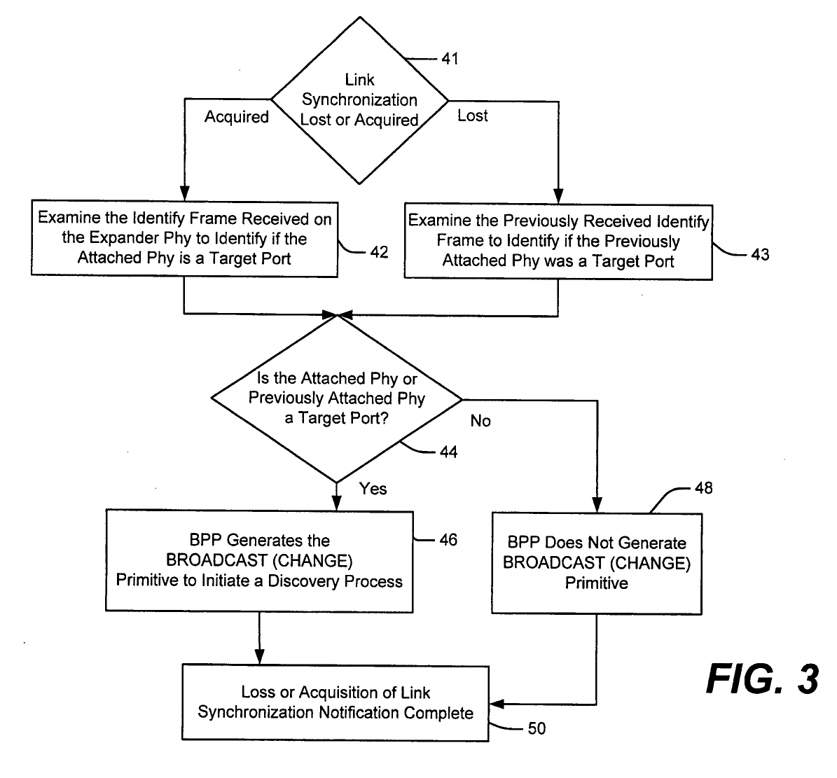

Shown in FIG. 3 is a flow diagram of a series of method steps for managing the issuance of a BROADCAST (CHANGE) primitive following the loss or acquisition of link synchronization on a link in a domain having only one expander. The loss or acquisition of link synchronization is defined as a change in link synchronization status. At step 41, after a loss or acquisition of link synchronization has occurred, it is determined if link synchronization was lost or acquired. If link synchronization was acquired, the flow diagram branches to step 42 and the broadcast primitive processor examines the IDENTIFY address frame that is passed to the expander phy from the phy that is coupled to the expander phy to determine if the phy that is coupled to the expander phy is a target port. If link synchronization was lost, the flow diagram branches to step 43 and the broadcast primitive processor examines the previously received IDENTIFY address frame, which was received at a time when the link was synchronized, to determine if the phy attached to the expander is a target port. With reference to the IDENTIFY address frame of FIG. 2, whether the phy attached to the expander phy is or was a target port can be determined by examining the target port bits 38 of byte 3. If at least one of these bits is set to a logical one, the phy attached to the expander phy that lost or acquired link synchronization is or was a target port. At step 44, if the phy attached to the expander phy is or was a target port, the flow diagram branches to step 46, where the broadcast primitive processor issues a BROADCAST (CHANGE) primitive to begin the discovery process for the ports within the SAS domain. Following step 46, the loss or acquisition of link synchronization notification concludes at step 50. If it is determined at step 44 that the phy attached to the expander phy that lost or acquired link synchronization was not a target port, the flow diagram branches to step 48, where it is indicated that the broadcast primitive processor does not generate a BROADCAST (CHANGE) primitive. Following step 48, the flow diagram concludes at step 50.

The sequence of FIG. 3 demonstrates that a BROADCAST (CHANGE) primitive is only generated if the phy attached to the expander phy that lost or acquired link synchronization is or was a target port. Generating a BROADCAST (CHANGE) primitive when the phy attached to the expander phy is or was a target port permits the initiator ports to conduct discovery when there has been a change to the configuration of target ports in the SAS domain or network. If the phy attached to the expander phy was not a target port, the BROADCAST (CHANGE) primitive is not generated. If the phy attached to the expander phy is or was an initiator port, it is not necessary to generate a BROADCAST (CHANGE) primitive, as it is not necessary for each initiator port to recognize configuration changes to every other initiator port. In addition, because the SAS domain of FIG. 1 includes only one expander, the routing table of the expander is automatically updated, as all of the connections within the expander are direct routes. If the phy attached to the expander phy is both an initiator and target port, then the BROADCAST (CHANGE) primitive is generated.

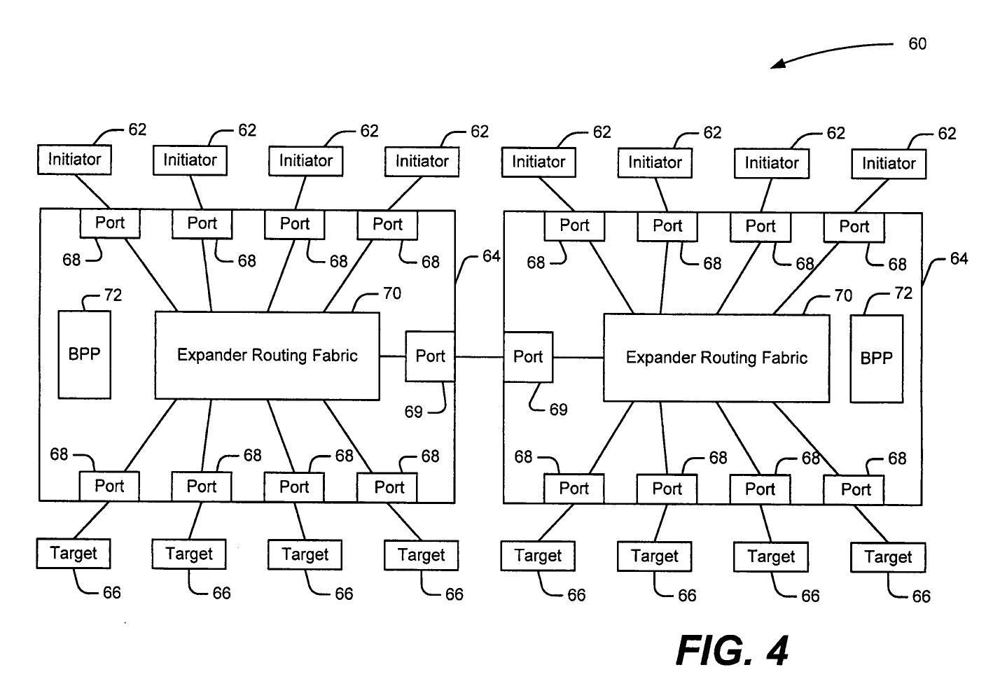

Shown in FIG. 4 is a diagram of a SAS network, which is indicated generally at 60. In contrast with the network of FIG. 1, the network of FIG. 4 includes a SAS domain that includes multiple expanders. In the example of FIG. 4, two expanders 64 are shown. Each expander 64 includes a broadcast primitive processor 72 and an expander routing fabric 70. Coupled to the expander routing fabric are a number of ports 68, each of which is coupled to an initiator port 62 or a target port 66. The two expanders are coupled to each other by ports 69.

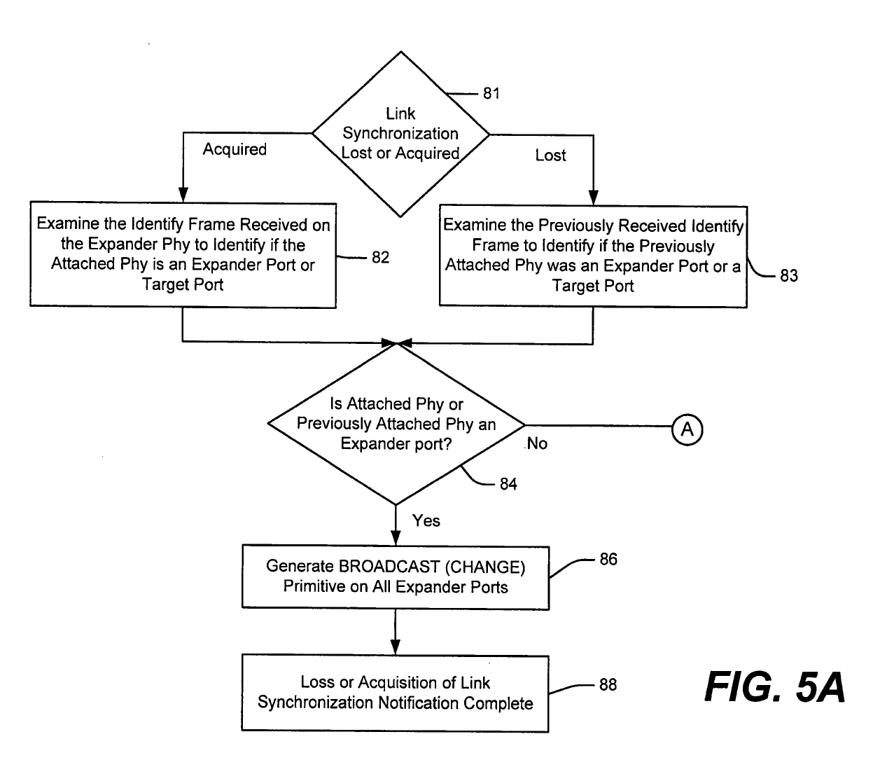

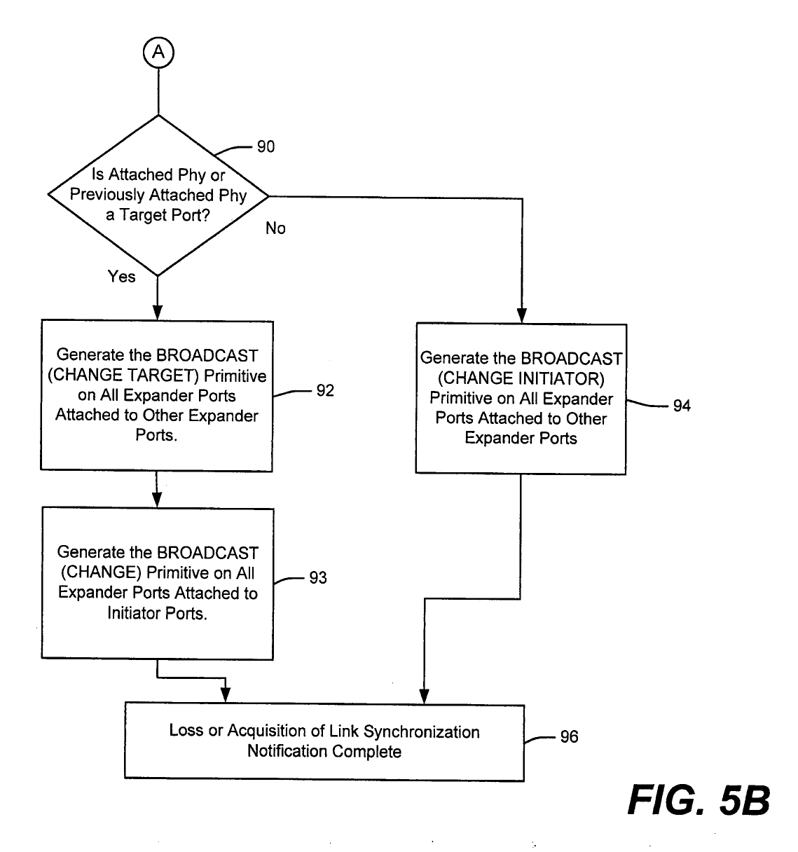

Shown in FIGS. 5A and 5B are flow diagrams of a method for generating broadcast primitives following the loss or acquisition of link synchronization on a link in a SAS domain having multiple expanders. The method involves the establishment of two additional primitives. The first new primitive, BROADCAST (CHANGE TARGET), will be issued between expander-to-expander ports 69 of FIG. 4 when there is a configuration change to a target port, and the second new primitive, BROADCAST (CHANGE INITIATOR), will be issued between expander-to-expander ports 69 of FIG. 4 when there is a change to an initiator port.

With reference to FIG. 5A, after a loss or acquisition of link synchronization on a link coupled to one of the expanders, it is determined at step 81 if link synchronization was lost or acquired. If the link acquired link synchronization, the flow diagram branches to step 82 and the broadcast primitive processor examines the IDENTIFY address frame passed to the expander phy from the phy attached to the expander phy to determine if the attached phy is an expander port. Determining whether a port is and expander port is accomplished by examining the DEVICE TYPE 40 in byte 1 of FIG. 2. If link synchronization is lost, the flow diagram branches to step 83 and the broadcast primitive processor examines the previously received IDENTIFY address frame, which was received at a time when the link was synchronized, to determine if the phy attached to the expander phy was an expander port. At step 84, it is determined if the link that lost or acquired link synchronization is or was a link between two expanders, such as the link between ports 69 in FIG. 4. If the link that lost or acquired link synchronization is or was a link between two expanders, the flow diagram branches to step 86, where a BROADCAST (CHANGE) primitive is generated and transmitted to all ports of the SAS network through each expander of the network. Following step 86, the loss or acquisition of link synchronization notification concludes at step 88.

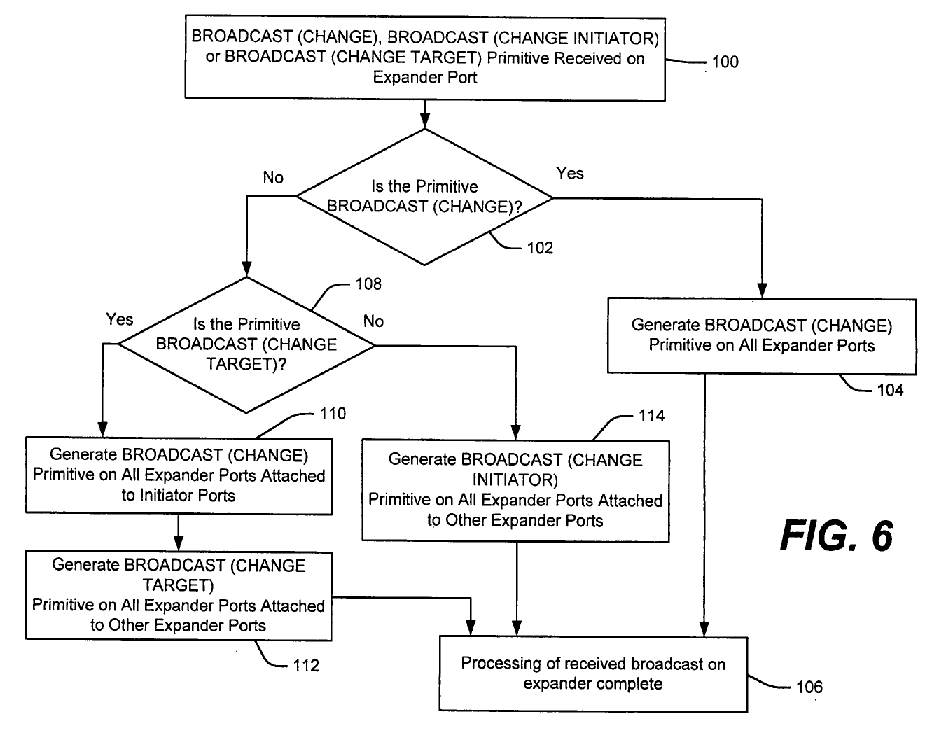

If it is determined at step 84 that the link that lost or acquired link synchronization was not a link between two expanders, the flow diagram jumps to point A in FIG. 5B. At step 90, it is determined if the link is or was between an expander and a target port. The determination of whether the link involves a target port is made by examining the target port bits 38 of the IDENTIFY ADDRESS frame (FIG. 2) examined in 82 or 83 of FIG. 5A. If it is determined that the link involves a target port, the broadcast primitive processor generates a BROADCAST (CHANGE TARGET) primitive at step 92 that is distributed to only those expander ports that are coupled to other expander ports. In step 93, the broadcast primitive processor generates a BROADCAST (CHANGE) primitive that is distributed to only those expander ports that are coupled initiator ports. In this manner, the initiator ports directly attached to the expander where the link lost or acquired link synchronization conduct discovery of changes to the target ports of the SAS domain. Initiator ports on expanders that were not directly connected to the expander where the link lost or acquired link synchronization are described in FIG. 6. Following step 93, the loss or acquisition of link synchronization notification for the expander that included the link that lost or acquired link synchronization concludes at step 96. If it is determined at step 90 that the link that lost or acquired link synchronization was not between an expander port and a target port, then it is known that the link that lost or acquired link synchronization was between an expander port and an initiator port. At step 94, the broadcast primitive processor generates a BROADCAST (CHANGE INITIATOR) primitive that is transmitted only to those expander ports attached to expander ports.

Any expander port that receives a BROADCAST (CHANGE), BROADCAST (CHANGE TARGET), or a BROADCAST (CHANGE INITIATOR) primitive will follow the flow diagram of FIG. 6. FIG. 6 shows a method of generating broadcast primitives on expanders that receive a BROADCAST (CHANGE), BROADCAST (CHANGE TARGET), or BROADCAST (CHANGE INITIATOR) from another expander in the domain. The method involves the processing and distribution of the additional primitives BROADCAST (CHANGE), BROADCAST (CHANGE TARGET), and BROADCAST (CHANGE INITIATOR) defined above. At step 100 of FIG. 6, a BROADCAST (CHANGE), BROADCAST (CHANGE TARGET), or BROADCAST (CHANGE INITIATOR) is received on an expander port attached to a phy on another expander port. At step 102, it is determined if the received primitive is a BROADCAST (CHANGE). If the received primitive is a BROADCAST (CHANGE) primitive, the flow diagram branches to step 104 and the broadcast primitive processor generates a BROADCAST (CHANGE) primitive on all expander ports, except the port that received the original BROADCAST (CHANGE) primitive. Following step 104, the processing of the received broadcast by an expander concludes at step 106.

If at step 102, if it is determined that the received primitive is not a BROADCAST (CHANGE), the flow diagram branches to step 108 and it is determined if the received primitive is a BROADCAST (CHANGE TARGET) primitive. If the received primitive is a BROADCAST (CHANGE TARGET) primitive, the flow diagram branches to step 110 and the broadcast primitive processor generates a BROADCAST (CHANGE) primitive on all expander ports directly attached to initiator ports. Following step 110, in step 112, the broadcast primitive processor generates a BROADCAST (CHANGE TARGET) primitive on all expander ports directly attached to other expander ports, except the port that received the original BROADCAST (CHANGE TARGET) primitive. Following step 112, the processing of the received broadcast by an expander concludes at step 106.

If at step 108, it is determined that the received primitive is not a BROADCAST (CHANGE TARGET), the flow diagram branches to step 114 and the broadcast primitive processor generates a BROADCAST (CHANGE INITIATOR) primitive on all expander ports directly attached to other expander ports, except the port that received the original BROADCAST (CHANGE INITIATOR) primitive. Following step 114, the processing of the received broadcast by an expander concludes at step 106.

The method set out in FIGS. 5A, 5B, and 6 provides a method for distributing a broadcast primitive to only those ports affected by the primitive. Because of the point-to-point architecture of SAS networks, configuration changes to initiator ports need not be discovered by other initiator ports, whereas changes to target ports should be discovered by initiator ports of the domain. Similarly, configuration changes to initiator ports need not be recognized by other initiator ports and are ignored by target ports, but should be recognized by the expander ports of the domain to update routing tables. By using a targeted approach to the distribution of broadcast primitives following a loss or acquisition of link synchronization, the possibility of contention for network resources during network discovery is diminished, if not entirely eliminated.

Although the system and method disclosed herein has been described with reference to SAS networks, the system and method disclosed herein could be used with any network having a discovery procedure and a point-to-point architecture. It should also be recognized that the system and method disclosed herein need not be implemented with the primitives set disclosed herein. Rather, the system and method disclosed herein may be employed with any primitives or command sets that is operable to limit the discovery functions of the network on the basis of the ports involved in a configuration or change sequence. Although the present disclosure has been described in detail, it should be understood that various changes, substitutions, and alterations can be made hereto without departing from the spirit and the scope of the invention as defined by the appended claims.

What is claimed is:

1. A method for managing network operation following a change in link synchronization status of a link in the network, wherein the network includes point-to-point connections comprising initiator ports and target ports, comprising:
identifying the change in link synchronization status in the network;
determining if the link involves a target port; and
if the link involves a target port, initiating a discovery sequence such that initiator ports in the network recognize any configuration changes to the target port;
wherein the discovery sequence is not initiated if the link does not involve a target port.

2. The method for managing network operation of claim 1, wherein the network is a Serial Attached SCSI network.

3. The method for managing network operation of claim 2, wherein the Serial Attached SCSI network includes a domain that includes only a single expander.

4. The method for managing network operation of claim 1, wherein the step of determining if the link involves a target port comprises the step of examining configuration data passed between the two links.

5. The method for managing network operation of claim 4,
wherein the network is an Serial Attached SCSI network; and
wherein the step of determining if the link involves a target port comprises the step of examining the IDENTIFY address frame passed between the two entities.

6. The method for managing network operation of claim 5,
wherein the SAS network includes a domain that includes only a single expander; and
wherein the determining step is performed by the broadcast primitive processor of an expander of the network.

7. The method for managing network operation of claim 6, wherein the discovery sequence is initiated by the issuance of a BROADCAST (CHANGE) primitive by the broadcast primitive processor.

8. A method for managing network operation following a change in link synchronization status of a link in the network, wherein the network includes point-to-point connections comprising initiator ports and target ports, comprising:
identifying a change in link synchronization status of a link in the network;
determining if the link involves a target port; and
if the link involves a target port, transmitting a primitive directed only to the initiator ports to cause the initiator ports to enter a discovery sequence in which the initiator ports in the network recognize any configuration changes to the target port.

9. The method for managing network operation of claim 8, wherein the network is a Serial Attached SCSI network.

10. The method for managing network operation of claim 9, wherein the Serial Attached SCSI network includes a domain that includes multiple expanders.

11. The method for managing network operation of claim 8, wherein the step of determining if the link involves a target port comprises the step of examining configuration data passed between the two links.

12. The method for managing network operation of claim 11,
wherein the network is an Serial Attached SCSI network; and
wherein the step of determining if the link involves a target port comprises the step of examining the IDENTIFY address frame passed between the two entities.

13. The method for managing network operation of claim 12,
wherein the SAS network includes a domain that includes multiple expanders; and
wherein the determining step is performed by the broadcast primitive processor of an expander of the network.

14. The method for managing network operation of claim 6, wherein the discovery sequence is initiated by the issuance of a BROADCAST (CHANGE TARGET) primitive to the initiator ports of the network by the broadcast primitive processor.

15. A method for managing network operation following a change in link synchronization status of a link in the network, wherein the network includes point-to-point connections comprising initiator ports and target ports, comprising:
identifying a change in link synchronization status of a link in the network;
determining if the link involves an initiator port; and
if the link involves an initiator port, transmitting a primitive directed only to the target ports to cause the target ports to enter a discovery sequence in which the target ports in the network recognize any configuration changes to the initiator port.

16. The method for managing network operation of claim 15, wherein the network is a Serial Attached SCSI network.

17. The method for managing network operation of claim 16, wherein the Serial Attached SCSI network includes a domain that includes multiple expanders.

18. The method for managing network operation of claim 15, wherein the step of determining if the link involves an initiator port comprises the step of examining configuration data passed between the two endpoints of the link.

19. The method for managing network operation of claim 18,
wherein the network is an Serial Attached SCSI network; and
wherein the step of determining if the reset link involves an initiator port comprises the step of examining the IDENTIFY address frame passed between the two endpoints of the link.

20. The method for managing network operation of claim 19,
wherein the SAS network includes a domain that includes multiple expanders; and
wherein the determining step is performed by the broadcast primitive processor of an expander of the network.

21. The method for managing network operation of claim 6, wherein the discovery sequence is initiated by the issuance of a BROADCAST (CHANGE INITIATOR) primitive to the target ports of the network by the broadcast primitive processor.
